SEQUENCE LISTING (5 sequences)

SEQ ID NO: 1 - DNA, 1077 bp, Phanerochaete chrysosporium
  source 1..1077: mol_type = genomic DNA
gcagtctgtccagacggtacccgcgtcaccaacgcggcgtgctgcgctgcagtctgtccagacggtacccgcgtcaccaacgcggcgtgctgcgcttgtggcgaagatgcccacgaagtcatccgtctgaccttccacgacgctattgcaatctcccagagcctaggtcctcaggctggcggcggtgctgacggctccatgctgcacttcccgacaatcgagcccaacttctccgccaacaacggcatcgatgactccgtcaacaacttgcttcccttcatgcagaaacacgacaccatcagtgccgccgatcttgtacagttcgccggtgcggtcgcgctgagcaactgcccaggtgctcctcgcctcgagttcatggctggacgtccgaacactaccatccccgcagttgagggcctcattcctgagcctcaagacagcgtcaccaaaatcctgcagcgcttcgaggacgccggcaacttctcgccgttcgaggtcgtctcgctcctggcttcacacaccgttgctcgtgcggacaaggtcgacgagaccatcgatgctgcgcccttcgactcgacacccttcaccttcgacacccaggtgttcctcgaggtcctgctcaagggcacaggcttcccgggctcgaacaacaacaccggcgaggtgatgtcgccgctcccactcggcagcggcagcgacacgggcgagatgcgcctgcagtccgactttgcgctcgcgcgcgacgagcgcacggcgtgcttctggcagtcgttcgtcaacgagcaggagttcatggcggcgagcttcaaggccgcgatggcgaagctcgcgatcctcggccacagccgcagcagcctcatcgactgcagcgacgtcgtccccgtcccgaagcccgccgtcaacaagcccgcgacgttccccgcgacgaagggccccaaggatctcgacacactcacgtgcaaggccctcaagttcccgacgctgacctctgaccccggtgctaccgagaccctcatcccccactgctccaacggcggcatgtcctgccctggtgttcagttcgatggccctgcctga

SEQ ID NO: 2 - protein, 358 aa, Phanerochaete chrysosporium
AVCPDGTRVTNAACCAAVCPDGTRVTNAACCACGEDAHEVIRLTFHDAIAISQSLGPQAGGGADGSMLHFPTIEPNFSANNGIDDSVNNLLPFMQKHDTISAADLVQFAGAVALSNCPGAPRLEFMAGRPNTTIPAVEGLIPEPQDSVTKILQRFEDAGNFSPFEVVSLLASHTVARADKVDETIDAAPFDSTPFTFDTQVFLEVLLKGTGFPGSNNNTGEVMSPLPLGSGSDTGEMRLQSDFALARDERTACFWQSFVNEQEFMAASFKAAMAKLAILGHSRSSLIDCSDVVPVPKPAVNKPATFPATKGPKDLDTLTCKALKFPTLTSDPGATETLIPHCSNGGMSCPGVQFDGPA

SEQ ID NO: 3 - DNA, 1976 bp, synthetic construct
  source 1..1976: mol_type = other DNA
gtgcagcgtgacccggtcgtgcccctctctagagataatgagcattgcatgtctaagttataaaaaattaccacatattttttttgtcacacttgtttgaagtgcagtttatctatctttatacatatatttaaactttactctacgaataatataatctatagtactacaataatatcagtgttttagagaatcatataaatgaacagttagacatggtctaaaggacaattgagtattttgacaacaggactctacagttttatctttttagtgtgcatgtgttctcctttttttttgcaaatagcttcacctatataatacttcatccattttattagtacatccatttagggtttagggttaatggtttttatagactaatttttttagtacatctattttattctattttagcctctaaattaagaaaactaaaactctattttagtttttttatttaataatttagatataaaatagaataaaataaagtgactaaaaattaaacaaataccctttaagaaattaaaaaaactaaggaaacatttttcttgtttcgagtagataatgccagcctgttaaacgccgtcgacgagtctaacggacaccaaccagcgaaccagcagcgtcgcgtcgggccaagcgaagcagacggcacggcatctctgtcgctgcctctcgagagttccgctccaccgttggacttgctccgctgtcggcatccagaaattgcgtggcggagcggcagacgtgagccggcacggcaggcggcctcctcctcctctcacggcacggcagctacgggggattcctttcccaccgctccttcgctttcccttcctcgcccgccgtaataaatagacaccccctccacaccctctttccccaacctcgtgttgttcggagcgcacacacacacaaccagatctcccccaaatccacccgtcggcacctccgcttcaaggtacgccgctcgtcctccccccccccccctctctaccttctctagatcggcgttccggtccatggttagggcccggtagttctacttctgttcatgtttgtgttagatccgtgtttgtgttagatccgtgctgctagcgttcgtacacggatgcgacctgtacgtcagacacgttctgattgctaacttgccagtgtttctctttggggaatcctgggatggctctagccgttccgcagacgggatcgatttcatgattttttttgtttcgttgcatagggtttggtttgcccttttcctttatttcaatatatgccgtgcacttgtttgtcgggtcatcttttcatgcttttttttgtcttggttgtgatgatgtggtctggttgggcggtcgttctagatcggagtagaattctgtttcaaactacctggtggatttattaattttggatctgtatgtgtgtgccatacatattcatagttacgaattgaagatgatggatggaaatatcgatctaggataggtatacatgttgatgcgggttttactgatgcatatacagagatgctttttgttcgcttggttgtgatgatgtggtgtggttgggcggtcgttcattcgttctagatcggagtagaatactgtttcaaactacctggtgtatttattaattttggaactgtatgtgtgtgtcatacatcttcatagttacgagtttaagatggatggaaatatcgatctaggataggtatacatgttgatgtgggttttactgatgcatatacatgatggcatatgcagcatctattcatatgctctaaccttgagtacctatctattataataaacaagtatgttttataattattttgatcttgatatacttggatgatggcatatgcagcagctatatgtggatttttttagccctgccttcatacgctatttatttgcttggtactgtttcttttgtcgatgctcaccctgttgtttggtgttacttctgca

SEQ ID NO: 4 - DNA, 2319 bp, Phanerochaete chrysosporium
  source 1..2319: mol_type = genomic DNA
aattacagacttcaggttgttcgcgaggaggcatcttcgcagcctcctgaagcataacggattcatatggtcgcctccatgtgctacctcatgacttcgcaggcggagtcagaggactgctccaaaccagaaatggggcacttcatcgccgtcatgaacatgggacagaccaggccttgctccctcctaactgtctgccttgcacggaaagttgcagtcgcacaattggttattggagaactgcggctatccgcgaatcataccctccaagatgaacgctcagtagggaggtgtataaaggcgtcgacggtatcctccctactccagccagcggttgctctgtacacttccactgcataaccatgtttcttgacaccacaccattccgtgctgatgagccctacgatgtcttcatcgctggcagcggaccgattggtgccacgttcgccaagctctgcgtcgacgccaaccttcgcgtctgcatggtcgaaatcggcgcggccgattcgttcaccagcaagccgatgaaaggcgaccccaacgcgccccgctcggtgcaattcggccccggccaggttcccatccctgggtatcataagaagaacgagatcgagtaccagaaggacatcgatagattcgtgaatgttatcaagggagcgttgagcacgtgctccatcccgacctctaacaatcacattgccaccttggacccttctgttgtgtccaactccctcgacaaacctttcatctcactcggcaaaaaccccgctcagaacccgttcgtgaatctcggcgccgaggctgtcacgcgcggcgtcgggggcatgagcactcactggacgtgcgcaacccccgagtttttcgccccagctgacttcaacgccccgcaccgcgagcgcccgaagctgtcgacggacgctgcagaggacgcgcgcatctggaaggacctctacgcccaggcgaaggagatcatcggcacttctaccacagagttcgaccactcgatccggcacaacctcgtgctgcgtaagtacaatgatatcttccagaaggaaaacgtcatacgcgaattctcgccgctgccgctggcatgccaccgtctgacggaccccgactacgtcgagtggcacgcaaccgaccgcatcctcgaggagctcttcactgaccccgtgaagcgcggccgcttcacactcctcaccaaccatcgctgcacgaagctcgtgttcaagcactacaggccgggggaggagaatgaggtcgactatgccctcgtcgaggacctcctcccgcacatgcagaaccccgggaacccggcctccgtcaagaagatttatgctcgctcctatgtcgttgcctgcggtgctgtggcgactgcccaggtgcttgccaactcgcacatccctcctgatgatgtcgtcatccccttccccggaggcgagaagggctcgggcggaggcgaacgcgacgctaccatccctacacccctgatgcccatgctgggtaaatacattacggaacagcccatgactttctgccaagtcgtgctcgactcatccctcatggaggtcgtcaggaacccgccctggccgggcctcgactggtggaaggagaaggtcgcaaggcacgtggaggccttcccgaacgacccgatcccgatccccttccgcgaccccgagccgcaggtcacgatcaagttcacggaggagcacccgtggcacgttcagatccaccgcgacgccttctcgtacggcgccgtcgcggagaacatggacacgcgtgtgatcgtcgactaccgcttcttcgggtacaccgagccgcaggaggcgaacgagctcgtcttccagcagcactaccgcgatgcgtacgacatgccgcagcccacattcaagttcacgatgagccaggacgaccgtgcgcgcgcccgccgcatgatggatgacatgtgcaacattgccctcaagatcggcggctacctcccgggctctgagccgcagttcatgacacccggcctcgcgctgcacctcgcgggcacgactcgctgcggtctcgacacgcagaagaccgtcggaaacacgcactgcaaggtccacaacttcaacaatctctacgtcggcggcaacggcgtcattgagactggtttcgcggccaacccgacgctcacgtcgatttgctacgcgattcgcgcatcgaacgacatcatcgcgaagtttggtcgtcaccgcggctgagcagtagaggtgtcccgtgcccgctcaaatggcttgtaattgtagcgtgtattaggttcgaacatgtacaaatacaatggttatctgcgca

SEQ ID NO: 5 - DNA, 2502 bp, Zea mays
  source 1..2502: mol_type = genomic DNA
aagcttgccgagtgccatccttggacactcgataaagtatattttattttttttattttgccaaccaaactttttgtggtatgttcctacactatgtagatctacatgtaccattttggcacaattacatatttacaaaaatgttttctataaatattagatttagttcgtttatttgaatttcttcggaaaattcacatttaaactgcaagtcactcgaaacatggaaaaccgtgcatgcaaaataaatgatatgcatgttatctagcacaagttacgaccgatttcagaagcagaccagaatcttcaagcaccatgctcactaaacatgaccgtgaacttgttatctagttgtttaaaaattgtataaaacacaaataaagtcagaaattaatgaaacttgtccacatgtcatgatatcatatatagaggttgtgataaaaatttgataatgtttcggtaaagttgtgacgtactatgtgtagaaacctaagtgacctacacataaaatcatagagtttcaatgtagttcactcgacaaagactttgtcaagtgtccgataaaaagtactcgacaaagaagccgttgtcgatgtactgttcgtcgagatctctttgtcgagtgtcacactaggcaaagtctttacggagtgtttttcaggctttgacactcggcaaagcgctcgattccagtagtgacagtaatttgcatcaaaaatagctgagagatttaggccccgtttcaatctcacgggataaagtttagcttcctgctaaactttagctatatgaattgaagtgctaaagtttagtttcaattaccaccattagctctcctgtttagattacaaatggctaaaagtagctaaaaaatagctgctaaagtttatctcgcgagattgaaacagggccttaaaatgagtcaactaatagaccaactaattattagctattagtcgttagcttctttaatctaagctaaaaccaactaatagcttatttgttgaattacaattagctcaacggaattctctgtttttctaaaaaaaaactgcccctctcttacagcaaattgtccgctgcccgtcgtccagatacaatgaacgtacctagtaggaactcttttacacgctcggtcgctcgccgcggatcggagtccccggaacacgacaccactgtggaacacgacaaagtctgctcagaggcggccacaccctggcgtgcaccgagccggagcccggataagcacggtaaggagagtacggcgggacgtggcgacccgtgtgtctgctgccacgcagccttcctccacgtagccgcgcggccgcgccacgtaccagggcccggcgctggtataaatgcgcgccacctccgctttagttctgcatacagccaacccaannnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnngccaaaacgagcaggaagcaacgagagggtggcgcgcgaccgacgtgcgtacgtagcatgagcctgagtggagacgttggacgtgtatgtatatacctctctgcgtgttaactatgtacgtaagcggcaggcagtgcaataagtgtggctctgtagtatgtacgtgcgggtacgatgctgtaagctactgaggcaagtccataaataaataatgacacgtgcgtgttctataatctcttcgcttcttcatttgtccccttgcggagtttggcatccattgatgccgttacgctgagaacagacacagcagacgaaccaaaagtgagttcttgtatgaaactatgacccttcatcgctaggctcaaacagcaccccgtacgaacacagcaaattagtcatctaactattagcccctacatgtttcagacgatacataaatatagcccatccttagcaattagctattggccctgcccatcccaagcaatgatctcgaagtatttttaatatatagtatttttaatatgtagcttttaaaattagaagataattttgagacaaaaatctccaagtatttttttgggtattttttactgcctccgtttttctttatttctcgtcacctagtttaattttgtgctaatcggctataaacgaaacagagagaaaagttactctaaaagcaactccaacagattagatataaatcttatatcctgcctagagctgttaaaaagatagacaactttagtggattagtgtatgcaacaaactctccaaatttaagtatcccaactacccaacgcatatcgttcccttttcattggcgcacgaactttcacctgctatagccgacgtacatgttcgttttttttgggcggcgcttactttcttccccgttcgttctcagcatcgcaactcaatttgttatggcggagaagcccttgtatcccaggtagtaatgcacagatatgcattattattattcataaaacgaattc

(19) United States
(12) Patent Application Publication
(10) Pub. No.: US 2025/0161732 A1
(43) Pub. Date: May 22, 2025

(54) COMPOSITIONS AND METHODS FOR DEGRADATION OF POLLUTANTS BY PLANT-PRODUCED MANGANESE PEROXIDASE

(71) Applicant: GREENLAB, INC., Jonesboro, AR (US)

(72) Inventors: Elizabeth E. Hood, Jonesboro, AR (US); Samira Narimannejad, Windsor (CA)

(21) Appl. No.: 18/953,934

(22) Filed: Nov. 20, 2024

Related U.S. Application Data
(60) Provisional application No. 63/600,812, filed on Nov. 20, 2023.
(60) Provisional application No. 63/603,246, filed on Nov. 28, 2023.

(51) Int. Cl. A62D 3/02; A62D 101/26; A62D 101/28

(52) U.S. Cl. CPC A62D 3/02; C12Y 111/01013; A62D 2101/26; A62D 2101/28

(57) ABSTRACT

The disclosure relates to methods for degrading and/or removing pollutants comprising a phenol, aniline, a hydrocarbon, or a combination thereof, in a waste material. Methods include providing a viable corn plant expressing a fungus-derived recombinant manganese peroxidase in seeds of the corn plant, growing the corn plant, harvesting the seeds, and contacting one or more composition(s) comprising (1) at least a portion of the seeds, and (2) a peroxide or a peroxide source with the waste material comprising the pollutant to remove or degrade the pollutant.

### REFERENCE TO RELATED APPLICATIONS

This application claims benefit of priority to U.S. Provisional Patent Application No. 63/600,812, filed Nov. 20, 2023, and to U.S. Provisional Patent Application No. 63/603,246, filed Nov. 28, 2023, which are each incorporated herein by reference in their entireties.

### INCORPORATION OF SEQUENCE LISTING

The instant application contains a sequence listing, which has been submitted in XML file format by electronic submission and is incorporated herein by reference in its entirety. The XML file, created on Nov. 19, 2024, is named P14622US02.txt and is 13,610 bytes in size.

### FIELD

Disclosed herein are novel methods for removal of contaminants from industrial and municipal waste. Application of compositions comprising corn seeds expressing heterologous fungal-derived manganese peroxidase enzymes to the waste provides efficient removal of the contaminants.

### BACKGROUND

The Manganese-dependent peroxidases (or manganese peroxidases) are ligninolytic enzymes produced by white rot fungi. One such fungus is the basidiomycete Phanerochaete chrysosporium which is capable of degrading lignin to the point of mineralization with H₂O and CO₂ as the final products. This degrading ability is due to the exocellular peroxidases such as various isozymes of lignin peroxidases (LiP) and manganese peroxidases (MnP) along with an extracellular H₂O₂-generating system. Manganese peroxidases are glycosylated heme protein peroxidases that catalyze the H₂O₂-dependent oxidation of Mn²⁺ to Mn³⁺. Mn³⁺ is subsequently chelated by organic acids to create the diffusible oxidants that attack phenolic lignin structures.

Several isozymes of manganese peroxidases from the fungus Phanerochaete chrysosporium have been described (Tien and Kirk. 1983. Lignin-degrading enzyme from the hymenomycete Phanerochaete chrysosporium Burds. Science 221:661-663; Glenn et al. 1983. An extracellular H₂O₂-requiring enzyme preparation involved in lignin biodegradation by the white rot basidiomycete Phanerochaete chrysosporium. Biochem. Biophys. Res. Commun. 114:1077-1083; Kuwahara et al. 1984. Separation and characterization of two extracellular H₂O₂-dependent oxidases from ligninolytic cultures of Phanerochaete chrysosporium. FEBS Lett. 169:247-250) and the major isozyme, MnPI (H3) has been characterized in detail (Gold and Alic. 1993. Molecular biology of the lignin-degrading basidiomycete Phanerochaete chrysosporium. Microbiol. Rev. 57:605-622) and its X-ray structure reported (Sundaramoorthy, M., K. Kishi, M. H. Gold, and T. L. Poulos. 1994. The crystal structure of manganese peroxidase from Phanerochaete chrysosporium at 2.06-A resolution. J Biol. Chem. 269:32759-32767). These isozymes are encoded by a family of structurally related genes that are expressed under nutrient-limiting conditions during secondary metabolic growth phase of the fungus (Gettemy et al. 1998. Reverse transcription—PCR analysis of the regulation of the manganese peroxidase gene family. Appl Environ Microbiol 64 (2): 569-74).

Commercial production of MnP enzymes has its application in the fields of paper making, waste treatment, bioremediation and others. In the pulp and paper industry, biological pulping and biological bleaching have the potential of improving the quality of pulp and paper, reducing energy costs and environmental pollution relative to traditional pulping and bleaching operations (U.S. Pat. No. 5,691,193). The technology has focused on white rot fungi that have complex extracellular ligninolytic enzymes such as MnP and LiP. Unlike the xylanases used in commercial bleaching to degrade hemicelluloses, peroxidases such as LiP and MnP have not been much tested in applications for manufacturing processes. This is simply due to the lack of effective methods for the production of commercially viable yields of enzyme. Scale-up to industrial process requirements presents challenges that are difficult to simulate in the laboratory or pilot-scale tests. Thus there is a need in industry for large-scale production of ligninolytic enzymes such as MnP.

### SUMMARY

The disclosure relates to methods for degrading and/or removing pollutants in a waste material. Methods include providing a viable corn plant expressing a fungus-derived recombinant manganese peroxidase in seeds of the corn plant, growing the corn plant, harvesting the seeds, and contacting one or more composition(s) comprising (1) at least a portion of the seeds, and (2) a peroxide or a peroxide source, with the waste material comprising the pollutant to remove or degrade the pollutant.

### BRIEF DESCRIPTION OF THE DRAWINGS

The drawings illustrate generally, by way of example, but not by way of limitation, various embodiments discussed herein.

FIG. 1 is an illustration of a corn seed showing the location of the endosperm, pericarp, and germ.

FIG. 2 is a table showing compounds degraded by manganese peroxidase (MnP) expressed in transgenic corn.

FIG. 3 is a graph showing the absorbance of reaction products from purified recombinant manganese peroxidase (MnP) from corn seed (0.01 mg/mL) as compared to a purified fungal MnP (from commercially available P. chrysosporium) (1 mg/mL) using dimethoxyphenol (DMP) as the substrate. The corn-produced enzyme is >360 times more active on this substrate. Absorbance at 469 nm is 1.45 vs 0.4 (3×) and the corn-produced enzyme is 100× more dilute to reach that activity.

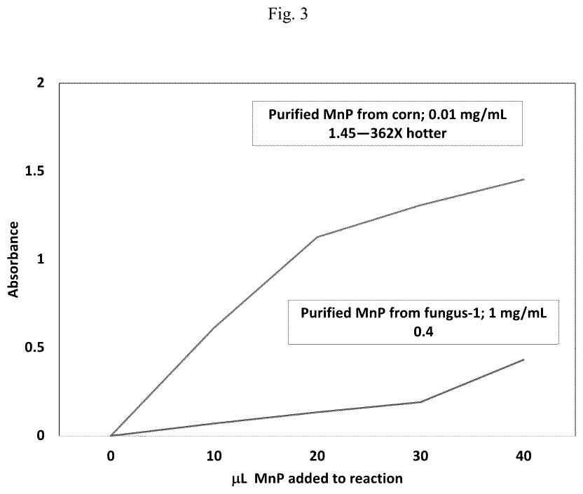

FIG. 4 is a graph showing the absorbance of reaction products from purified recombinant MnP from corn seed (0.01 mg/mL) as compared to a second source of purified fungal Mn peroxidase (from a second source of commercially available P. chrysosporium) (1.0 mg/mL) using dimethoxyphenol (DMP) as the substrate. The corn-produced enzyme is 475 times more active on this substrate. Absorbance at 469 nm is 1.9 vs 0.4 (4.75×) and the corn-produced enzyme is 100× more dilute to reach that activity.

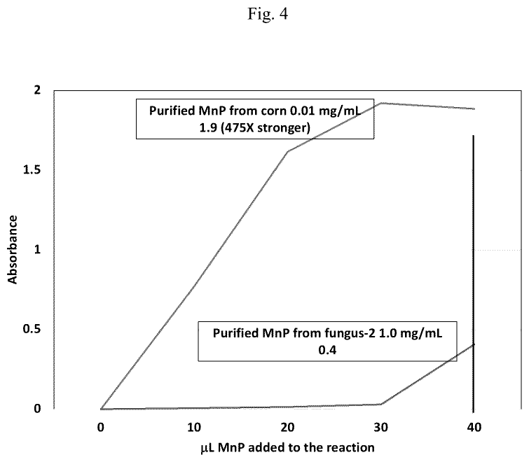

FIG. 5 is a graph showing the absorbance of reaction products from purified recombinant MnP from corn seed (0.01 mg/mL) is compared to a third purified MnP from a different fungus (0.01 mg/mL) using dimethoxyphenol (DMP) as the substrate. The corn-produced enzyme is 4 times more active on this substrate. Absorbance at 469 nm is 1.25 vs 3.1 (0.4) and the corn-produced enzyme is 100× more dilute to reach that activity.

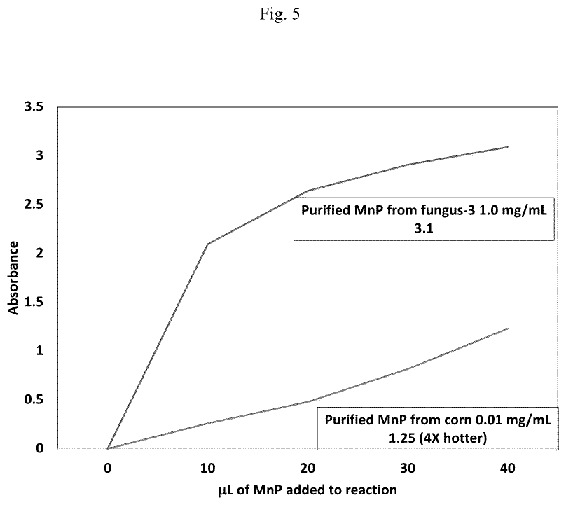

FIG. 6 is a table showing the detection of oxidative oligomers up to the tetramer stage of enzymatic products in soluble and insoluble parts of reactions with MnP, peroxide, and the indicated compounds.

### DETAILED DESCRIPTION

### Definitions

The term “and/or” where used herein is to be taken as specific disclosure of each of the two or more specified features or components with or without the other specified features. Thus, the term “and/or” as used in a phrase such as “A and/or B” herein is intended to include “A and B,” “A or B,” “A” (alone), and “B” (alone). Likewise, the term “and/or” as used in a phrase such as “A, B, and/or C” is intended to encompass each of the following embodiments: A, B, and C; A, B, or C; A or C; A or B; B or C; A and C; A and B; B and C; A (alone); B (alone); and C (alone).

As used herein, the terms “include,” “includes,” and “including” are to be construed as at least having the features to which they refer while not excluding any additional unspecified features.

As used herein, the phrase “allelic variant” refers to a polynucleotide or polypeptide sequence variant that occurs in a particular gene at a particular locus in a different strain, variety, or isolate of a given organism.

“Heterologous,” as used herein, means a nucleotide or polypeptide sequence that is not found in the native nucleic acid or protein, respectively.

The terms “polynucleotide” and “nucleic acid,” used interchangeably herein, refer to a polymeric form of nucleotides of any length, either ribonucleotides or deoxynucleotides. Thus, this term includes, but is not limited to, single-, double-, or multi-stranded DNA or RNA, genomic DNA, cDNA, DNA-RNA hybrids, or a polymer comprising purine and pyrimidine bases or other natural, chemically or biochemically modified, non-natural, or derivatized nucleotide bases. The terms “polynucleotide” and “nucleic acid” should be understood to include, as applicable to the embodiment being described, single-stranded (such as sense or antisense) and double-stranded polynucleotides.

The terms “polypeptide,” “peptide,” and “protein”, are used interchangeably herein, refer to a polymeric form of amino acids of any length, which can include genetically coded and non-genetically coded amino acids, chemically or biochemically modified or derivatized amino acids, and polypeptides having modified peptide backbones. The term includes fusion proteins, including, but not limited to, fusion proteins with a heterologous amino acid sequence, fusions with heterologous and homologous leader sequences, with or without N-terminal methionine residues; immunologically tagged proteins; and the like.

The term “naturally-occurring” as used herein as applied to a nucleic acid, a protein, a cell, or an organism, refers to a nucleic acid, cell, protein, or organism that is found in nature.

As used herein the term “isolated” is meant to describe a polynucleotide, a polypeptide, or a cell that is in an environment different from that in which the polynucleotide, the polypeptide, or the cell naturally occurs. An isolated genetically modified host cell may be present in a mixed population of genetically modified host cells.

As used herein, the term “exogenous nucleic acid” refers to a nucleic acid that is not normally or naturally found in and/or produced by a given bacterium, organism, or cell in nature. As used herein, the term “endogenous nucleic acid” refers to a nucleic acid that is normally found in and/or produced by a given bacterium, organism, or cell in nature. An “endogenous nucleic acid” is also referred to as a “native nucleic acid” or a nucleic acid that is “native” to a given bacterium, organism, or cell.

“Recombinant,” as used herein, means that a particular nucleic acid (DNA or RNA) is the product of various combinations of cloning, restriction, and/or ligation steps resulting in a construct having a structural coding or non-coding sequence distinguishable from endogenous nucleic acids found in natural systems. Generally, DNA sequences encoding the structural coding sequence can be assembled from cDNA fragments and short oligonucleotide linkers, or from a series of synthetic oligonucleotides, to provide a synthetic nucleic acid which is capable of being expressed from a recombinant transcriptional unit contained in a cell or in a cell-free transcription and translation system. Such sequences can be provided in the form of an open reading frame uninterrupted by internal non-translated sequences, or introns, which are typically present in eukaryotic genes. Genomic DNA comprising the relevant sequences can also be used in the formation of a recombinant gene or transcriptional unit. Sequences of non-translated DNA may be present 5′ or 3′ from the open reading frame, where such sequences do not interfere with manipulation or expression of the coding regions, and may indeed act to modulate production of a desired product by various mechanisms (see “DNA regulatory sequences”, below).

Thus, e.g., the term “recombinant” polynucleotide or “recombinant” nucleic acid refers to one which is not naturally occurring, e.g., is made by the artificial combination of two otherwise separated segments of sequence through human intervention. This artificial combination is often accomplished by either chemical synthesis means, or by the artificial manipulation of isolated segments of nucleic acids, e.g., by genetic engineering techniques. Such is usually done to replace a codon with a redundant codon encoding the same or a conservative amino acid, while typically introducing or removing a sequence recognition site. Alternatively, it is performed to join together nucleic acid segments of desired functions to generate a desired combination of functions. This artificial combination is often accomplished by either chemical synthesis means, or by the artificial manipulation of isolated segments of nucleic acids, e.g., by genetic engineering techniques.

Similarly, the term “recombinant” polypeptide refers to a polypeptide which is not naturally occurring, e.g., is made by the artificial combination of two otherwise separated segments of amino sequence through human intervention. Thus, e.g., a polypeptide that comprises a heterologous amino acid sequence is recombinant.

By “construct” or “vector” is meant a recombinant nucleic acid, generally recombinant DNA, which has been generated for the purpose of the expression and/or propagation of a specific nucleotide sequence(s), or is to be used in the construction of other recombinant nucleotide sequences.

The terms “DNA regulatory sequences,” “control elements,” and “regulatory elements,” used interchangeably herein, refer to transcriptional and translational control sequences, such as promoters, enhancers, polyadenylation signals, terminators, protein degradation signals, and the like, that provide for and/or regulate expression of a coding sequence and/or production of an encoded polypeptide in a host cell.

The term “transformation” is used interchangeably herein with “genetic modification” and refers to a permanent or transient genetic change induced in a cell following introduction of new nucleic acid (e.g., DNA exogenous to the cell) into the cell. Genetic change (“modification”) can be accomplished either by incorporation of the new nucleic acid into the genome of the host cell, or by transient or stable maintenance of the new nucleic acid as an episomal element. Where the cell is a eukaryotic cell, a permanent genetic change is generally achieved by introduction of new DNA into the genome of the cell. In prokaryotic cells, permanent changes can be introduced into the chromosome or via extrachromosomal elements such as plasmids and expression vectors, which may contain one or more selectable markers to aid in their maintenance in the recombinant host cell. Suitable methods of genetic modification include viral infection, transfection, conjugation, protoplast fusion, electroporation, particle gun technology, calcium phosphate precipitation, direct microinjection, and the like. The choice of method is generally dependent on the type of cell being transformed and the circumstances under which the transformation is taking place (i.e. in vitro, ex vivo, or in vivo). A general discussion of these methods can be found in Ausubel, et al, Short Protocols in Molecular Biology, 3rd ed., Wiley & Sons, 1995.

“Operably linked” refers to a juxtaposition wherein the components so described are in a relationship permitting them to function in their intended manner. For instance, a promoter is operably linked to a coding sequence if the promoter affects its transcription or expression. As used herein, the terms “heterologous promoter” and “heterologous control regions” refer to promoters and other control regions that are not normally associated with a particular nucleic acid in nature. For example, a “transcriptional control region heterologous to a coding region” is a transcriptional control region that is not normally associated with the coding region in nature.

A “host cell,” as used herein, denotes an in vivo or in vitro eukaryotic cell, a prokaryotic cell, or a cell from a multicellular organism (e.g., a cell line) cultured as a unicellular entity, which eukaryotic or prokaryotic cells can be, or have been, used as recipients for a nucleic acid (e.g., an expression vector), and include the progeny of the original cell which has been genetically modified by the nucleic acid. It is understood that the progeny of a single cell may not necessarily be completely identical in morphology or in genomic or total DNA complement as the original parent, due to natural, accidental, or deliberate mutation. A “recombinant host cell” (also referred to as a “genetically modified host cell”) is a host cell into which has been introduced a heterologous nucleic acid, e.g., an expression vector. For example, a subject prokaryotic host cell is a genetically modified prokaryotic host cell (e.g., a bacterium), by virtue of introduction into a suitable prokaryotic host cell of a heterologous nucleic acid, e.g., an exogenous nucleic acid that is foreign to (not normally found in nature in) the prokaryotic host cell, or a recombinant nucleic acid that is not normally found in the prokaryotic host cell; and a subject eukaryotic host cell is a genetically modified eukaryotic host cell, by virtue of introduction into a suitable eukaryotic host cell of a heterologous nucleic acid, e.g., an exogenous nucleic acid that is foreign to the eukaryotic host cell, or a recombinant nucleic acid that is not normally found in the eukaryotic host cell.

The term “conservative amino acid substitution” refers to the interchangeability in proteins of amino acid residues having similar side chains. For example, a group of amino acids having aliphatic side chains consists of glycine, alanine, valine, leucine, and isoleucine; a group of amino acids having aliphatic-hydroxyl side chains consists of serine and threonine; a group of amino acids having amide-containing side chains consists of asparagine and glutamine; a group of amino acids having aromatic side chains consists of phenylalanine, tyrosine, and tryptophan; a group of amino acids having basic side chains consists of lysine, arginine, and histidine; and a group of amino acids having sulfur-containing side chains consists of cysteine and methionine. Exemplary conservative amino acid substitution groups are: valine-leucine-isoleucine, phenylalanine-tyrosine, lysine-arginine, alanine-valine, and asparagine-glutamine.

A polynucleotide or polypeptide has a certain percent “sequence identity” to another polynucleotide or polypeptide, meaning that, when aligned, that percentage of bases or amino acids are the same, and in the same relative position, when comparing the two sequences. Sequence similarity can be determined in a number of different manners. To determine sequence identity, sequences can be aligned using the methods and computer programs, including BLAST, available over the world wide web at ncbi.nlm.nih.gov/BLAST. Sec, e.g., Altschul et al. (1990), J. Mol. Biol. 215:403-10. Another alignment algorithm is FASTA, available in the Genetics Computing Group (GCG) package, from Madison, Wisconsin, USA, a wholly owned subsidiary of Oxford Molecular Group, Inc. Other techniques for alignment are described in Methods in Enzymology, vol. 266: Computer Methods for Macromolecular Sequence Analysis (1996), ed. Doolittle, Academic Press, Inc., a division of Harcourt Brace & Co., San Diego, California, USA. Of particular interest are alignment programs that permit gaps in the sequence. The Smith-Waterman is one type of algorithm that permits gaps in sequence alignments. See Meth. Mol. Biol. 70:173-187 (1997). Also, the GAP program using the Needleman and Wunsch alignment method can be utilized to align sequences. See J. Mol. Biol. 48:443-453 (1970).

Before the present invention is further described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a,” “an,” and “the” include plural referents unless the context clearly dictates otherwise. Thus, for example, reference to “a Manganese peroxidase polypeptide” includes a plurality of such polypeptides and reference to “the guide RNA” includes reference to one or more guide RNAs and equivalents thereof known to those skilled in the art, and so forth. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination. All combinations of the embodiments pertaining to the invention are specifically embraced by the present invention and are disclosed herein just as if each and every combination was individually and explicitly disclosed. In addition, all sub-combinations of the various embodiments and elements thereof are also specifically embraced by the present invention and are disclosed herein just as if each and every such subcombination was individually and explicitly disclosed herein.

To the extent to which any of the preceding definitions is inconsistent with definitions provided in any patent or non-patent reference incorporated herein by reference, any patent or non-patent reference cited herein, or in any patent or non-patent reference found elsewhere, it is understood that the preceding definition will be used herein.

### Further Description

Peroxidase enzymes are heme proteins that contain an iron (III) protoporphyrin IX prosthetic group that is the center of their redox activity. Molecular weight of these enzymes ranges from 30,000 to 150,000 Da (Hamid and Rehman, 2009). They catalyze the reduction of peroxides, such as hydrogen peroxide, followed by the oxidation of a variety of organic and inorganic compounds. Peroxidases are represented by several specific enzymes, such as NADH peroxidase, glutathione peroxidase, iodide peroxidase, horseradish peroxidase (HRP), soybean peroxidase (SBP), as well as manganese peroxidase (MnP). The latter, produced by Phanerochaete chrysosporium, a white rot basidiomycete (fungus), has a role in degrading lignin in rotting trees to liberate the cellulose for fungal nutrition. Because of this activity, MnP has been investigated to determine its ability to catalyze the oxidation of several monoaromatic phenols and aromatic dyes in the presence of both divalent manganese and chelating buffers (Aitken and Irvine, 1989). MnP catalyzes the oxidation of Mn(II) to Mn(III) in the presence of Mn(III)-stabilizing ligands. The resulting Mn(III) complexes can then carry out the oxidation of organic substrates (Aitken et al., 1994).

In various embodiments, any suitable nucleic acid sequence encoding an MnP may be used in the methods described herein. Although the methods described herein report the expression of an MnP from P. chrysosporium, other homologous or substantially identical nucleic sequences or allelic variants thereof are contemplated to be capable of being expressed in plants in the same manner. In various embodiments, the transgenic corn comprises a nucleic acid segment encoding the recombinant MnP from Phanerochaete chrysosporium with at least 95% sequence identity to an amino acid sequence of SEQ ID NO: 1:

| | |
|---|---|
| gcagtctgtc cagacggtac ccgcgtcacc aacgcggcgt gctgcgctgc agtctgtcca | 60 |
| gacggtaccc gcgtcaccaa cgcggcgtgc tgcgcttgtg gcgaagatgc ccacgaagtc | 120 |
| atccgtctga ccttccacga cgctattgca atctcccaga gcctaggtcc tcaggctggc | 180 |
| ggcggtgctg acggctccat gctgcacttc ccgacaatcg agcccaactt ctccgccaac | 240 |
| aacggcatcg atgactccgt caacaacttg cttcccttca tgcagaaaca cgacaccatc | 300 |
| agtgccgccg atcttgtaca gttcgccggt gcggtcgcgc tgagcaactg cccaggtgct | 360 |
| cctcgcctcg agttcatggc tggacgtccg aacactacca tccccgcagt tgagggcctc | 420 |
| attcctgagc ctcaagacag cgtcaccaaa atcctgcagc gcttcgagga cgccggcaac | 480 |
| ttctcgccgt tcgaggtcgt ctcgctcctg gcttcacaca ccgttgctcg tgcggacaag | 540 |
| gtcgacgaga ccatcgatgc tgcgcccttc gactcgacac ccttcacctt cgacacccag | 600 |
| gtgttcctcg aggtcctgct caagggcaca ggcttcccgg gctcgaacaa caacaccggc | 660 |
| gaggtgatgt cgccgctccc actcggcagc ggcagcgaca cgggcgagat gcgcctgcag | 720 |
| tccgactttg cgctcgcgcg cgacgagcgc acggcgtgct tctggcagtc gttcgtcaac | 780 |
| gagcaggagt tcatggcggc gagcttcaag gccgcgatgg cgaagctcgc gatcctcggc | 840 |
| cacagccgca gcagcctcat cgactgcagc gacgtcgtcc ccgtcccgaa gcccgccgtc | 900 |
| aacaagcccg cgacgttccc cgcgacgaag ggccccaagg atctcgacac actcacgtgc | 960 |
| aaggccctca agttcccgac gctgacctct gaccccggtg ctaccgagac cctcatcccc | 1020 |
| cactgctcca acggcggcat gtcctgccct ggtgttcagt tcgatggccc tgcctga | 1077 |

The amino acid sequence of the MnP shown above in SEQ ID NO: 1 is shown below (SEQ ID NO: 2):

AVCPDGTRVT NAACCAAVCP DGTRVTNAAC CACGEDAHEV
IRLTFHDAIA ISQSLGPQAG GGADGSMLHF PTIEPNESAN
NGIDDSVNNL LPFMQKHDTI SAADLVQFAG AVALSNCPGA
PRLEFMAGRP NTTIPAVEGL IPEPQDSVTK ILQRFEDAGN
FSPFEVVSLL ASHTVARADK VDETIDAAPF DSTPFTEDTQ
VELEVLLKGT GFPGSNNNTG EVMSPLPLGS GSDTGEMRLQ
SDFALARDER TACFWQSFVN EQEFMAASEK AAMAKLAILG
HSRSSLIDCS DVVPVPKPAV NKPATFPATK GPKDLDTLTC
KALKFPTLTS DPGATETLIP HCSNGGMSCP GVQFDGPA

Organic compounds used in industry, such as phenols, chlorophenols, and anilines have highly toxic effects on human health. Therefore, because much of the waste from these industries is collected in ponds or released into the environment, negative health effects are apparent in the surrounding communities to these industries. A solution for the degradation of these phenol-derived chemicals is application of manganese peroxidase (Clough et al., 2006; Stewart et al., 1996).

Synthetic organic azo dyes are used commonly in different industries ranging from food, textile production, printing and pharmaceuticals, to colorize various raw materials. The majority of these dyes are recalcitrant to degradation or decolorization in the environment. Certain dyes, their precursors and some aromatic amine metabolites produced through biotransformation of dye compounds have been shown to be carcinogenic. The release of dyes into the environment constitutes water pollution, and the wastewater represents a serious environmental problem as well as a public health concern. Color removal, especially from textile wastewater, has been a big challenge over the last few decades. Now enzymatic treatment, including manganese peroxidase (Byrd and Hood, 2022), could be an economically attractive treatment that can effectively decolorize textile mill effluent (Chacko and Subramaniam, 2011).

Numerous other applications have been suggested for peroxidases. These include: organic and polymer syntheses, deodorization of swine manure, applications in the paper and pulp industry, as a component of biosensors (Izadyar et al., 2022), for analysis and diagnostic kits, enzyme immunoassays, and potentially for biofuel production processes (Hamid and Rehman, 2009). Analysis and diagnostic kits as well as immunoassays are primarily filled using horse radish peroxidase, produced from horseradish roots.

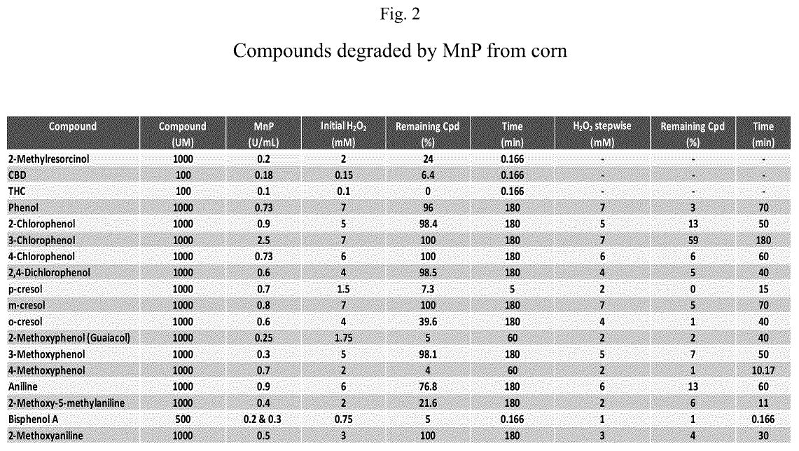

Methods for degrading a pollutant in waste material using recombinant manganese peroxidase (MnP) expressed in maize plants include the degradation of phenol and phenol derivatives. Waste material comprising phenol and phenol derivatives result from processes for coal conversion, petroleum refining, wood preservation, and manufacturing resins and plastics. Such waste material also includes metal coating, dyes, textiles, mining and dressing, and pulp and paper. As described herein, the MnP from P. chrysosporium expressed in maize plants was applied to each phenol and phenol derivative below, resulting in their degradation, as shown in FIG. 2:

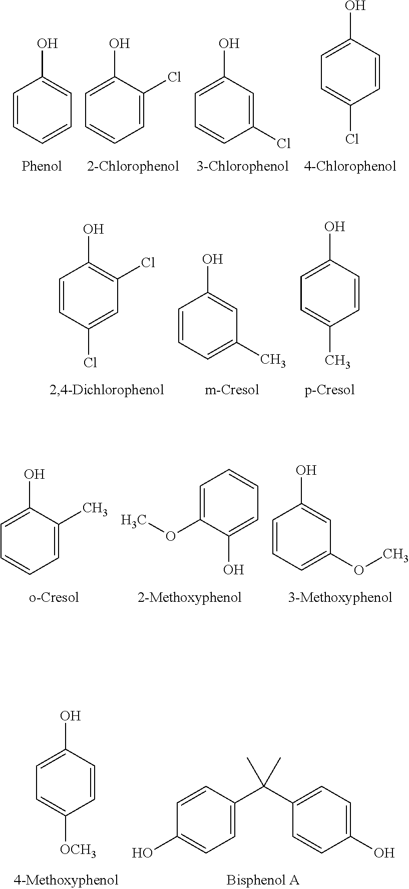

Methods for degrading a pollutant in waste material using recombinant MnP expressed in maize plants include the degradation pharmaceuticals and/or personal-care products. For example, the recombinant MnP expressed in maize plants can degrade cannabanoids. Waste material comprising cannabanoids include wastewater from the cultivation of cannabis plants. Improper disposal of cannabis wastewater can lead to soil and ultimately groundwater contamination, which may adversely impact nearby agricultural and/or residential areas. As described herein, the MnP from P. chrysosporium expressed in maize plants was applied to each of the cannabinoids below, resulting in their degradation, as shown in FIG. 2:

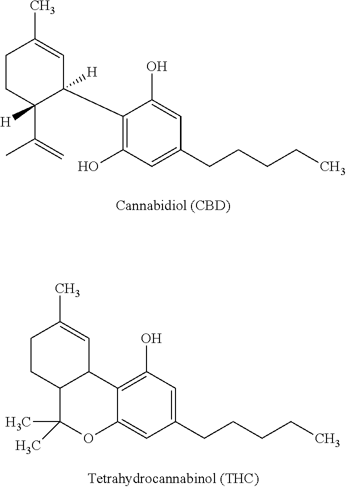

Methods for degrading a pollutant in waste material using recombinant MnP expressed in maize plants include the degradation of aromatic amines. Aromatic amines, such as aniline and anile derivatives, are used in various processes including production of dyes, rubber accelerators, photographic chemicals, pharmaceuticals, and explosives. Aniline and anile derivatives can be toxic to human health, causing respiratory distress, anoxia, fatigue, and other health issues. As described herein, the MnP from P. chrysosporium expressed in maize plants was applied to each of the aromatic amines below, resulting in their degradation, as shown in FIG. 2:

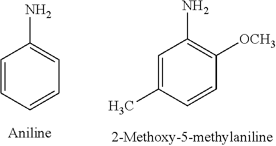

### Transgenic Maize

Production of MnP in transgenic maize provides a high yield of MnP with the benefit of the stability of its grain. Recombinant MnP can be expressed in transgenic maize as described in U.S. Pat. No. 7,067,726 (the '726 patent), which is incorporated herein by reference. As described in the '726 patent, a high level of expression of MnP from P. chrysosporium was achieved in viable transgenic corn seeds, which were shown to provide large-scale production of MnP and significant cost savings in producing MnP.

As used herein, the MnP gene is linked to a promoter which preferentially expressed MnP to the seed of the corn plant. Directing the expression to the seed resulted in a significant increase in protein accumulation and avoided plant health problems throughout the plant growth.

As used herein, a DNA molecule comprising a transformation/expression vector is engineered to incorporate a manganese peroxidase-encoding cDNA. There can be several isozymes for manganese peroxidase each encoded by a separate gene. Some examples are the mnp-1, mnp-2 and mnp-3 from P. chrysosporium (Pease et al. 1989. Manganese-dependent peroxidase from Phanerochacte chrysosporium. Primary structure deduced from cDNA sequence. J. Biol. Chem. 264:13531-35; Pribnow et al. 1989. Characterization of a cDNA encoding a manganese peroxidase, from the lignin-degrading basidiomycete Phanerochaete chrysosporium. J. Biol. Chem. 264:5036-40; Pease and Tien. 1992. Heterogeneity and regulation of manganese peroxidases from Phanerochaete chrysosporium. J Bacteriol. 174 (11): 3532-40); MnPL2 from Pleurotus eryngii (Ruiz-Duenas et al. 1999. Heterologous expression of Pleurotus eryngii peroxidase confirms its ability to oxidize Mn″ and different aromatic substrates. Appli & Environ. Microbiol. 65(10): 4705-07), mnp-2 from Dichomitus squalens (Li et al. 2001. Heterologous expression of a thermostable manganese peroxidase from Dichomitus squalens in Phanerochaete chrysosporium. Arch Biochem Biophy's. 385 (2): 348-56); and MnPI, MnPII and MnPIII from Phanerochaete sordida (Ruttimann-Johnson et al. 1994. Manganese peroxidases of the white rot fungus Phanerochaete sordida. Appl. Environ. Microbiol. 60 (2): 599-605). The list of MnP genes here is not intended to be comprehensive but illustrative. The gene used in the methods described herein is from P. chrysosporium. The cDNA sequence is SEQ ID NO: 1.

The methods available for construction of recombinant genes comprising various modifications for improved expression described above can differ in detail. However, the methods generally include the designing and synthesis of overlapping, complementary synthetic oligonucleotides which are annealed and ligated together to yield a gene with convenient restriction sites for cloning. The methods involved are standard methods for a molecular biologist.

Once the gene is engineered to contain desired features, such as the desired localization sequences, it is placed into an expression vector by standard methods. The selection of an appropriate expression vector will depend upon the method of introducing the expression vector into host cells. A typical expression vector contains prokaryotic DNA elements coding for a bacterial replication origin and an antibiotic resistance gene to provide for the growth and selection of the expression vector in the bacterial host; a cloning site for insertion of an exogenous DNA sequence, which in this context would code for manganese peroxidase; eukaryotic DNA elements that control initiation of transcription of the exogenous gene, such as a promoter; and DNA elements that control the processing of transcripts, such as transcription termination/polyadenylation sequences. It also can contain such sequences as are needed for the eventual integration of the vector into the plant chromosome.

In various embodiments, the expression vector also contains a gene encoding a selection marker that is functionally linked to a promoter that controls transcription initiation. For a general description of plant expression vectors and reporter genes, see Gruber et al. 1993. “Vectors for Plant Transformation” in Methods of Plant Molecular Biology and Biotechnology. CRC Press. p 89-119. In a preferred embodiment, the selective gene is a glufosinate-resistance encoding DNA and in another preferred embodiment can be the phosphinothricin acetyl transferase (“PAT”) or maize optimized PAT gene under the control of the CaMV 35S promoter. The gene confers resistance to bialaphos (Gordon-Kamm. 1990. The Plant Cell 2:603; Uchimiya et al. 1993. Bio/Technology 11:835; and Anzai et al, 1989. Mol. Gen. Gen. 219:492).

Promoter elements employed to control expression of MnP and the selection gene, respectively, can be any plant-compatible promoter. In the transgenic corn used in the methods described herein, a tissue specific promoter is provided to direct transcription of the DNA preferrentially to the seed. Use of such a sequence has been found to considerably increase the expression of MnP. One such promoter is the globulin promoter. This is the promoter of the maize globulin-1 gene, described by Belanger, F. C. and Kriz, A. L. 1991. Molecular Basis for Allelic Polymorphism of the maize Globulin-1 gene. Genetics 129:863-972. It also can be found as accession number AH001354.2 in the Genbank database. The nucleotide sequence of the Globulin-1 promoter is SEQ ID NO: 5. Another example is the phascolin promoter. See, Bustos et al. 1989. Regulation of B-glucuronidase expression in transgenic tobacco plants by an A/T-rich cis-acting sequence found upstream of a french bean B-phascolin gene. The Plant Cell. (1): 839-853. The '726 patent also provides a modified ubiquitin-like promoter, the nucleic acid sequence of which is provided in SEQ ID NO: 3.

A transgenic plant is produced that contains a DNA molecule, comprising elements as described above, integrated into its genome so that the plant expresses a heterologous MnP-encoding DNA sequence. To create such a transgenic plant, the expression vectors containing the gene can be introduced into protoplasts, into intact tissues, such as immature embryos and meristems, into callus cultures, or into isolated cells. Preferably, expression vectors are introduced into intact tissues. General methods of culturing plant tissues are provided, for example, by Miki et al. 1993. “Procedures for Introducing Foreign DNA into Plants” in Methods in Plant Molecular Biology and Biotechnology, Glick et al (eds) CRC Press pp. 67-68 and by Phillips et al. 1988 “Cell/Tissue Culture and In Vitro Manipulation” in Corn and Corn Improvement 3d Edit. Sprague ct al (cds) American Soc. of Agronomy pp. 345-387. The selectable marker incorporated in the expression cassette allows for selection of transformants.

Methods for introducing expression vectors into plant tissue available to one skilled in the art are varied and will depend on the plant selected. Procedures for transforming a wide variety of plant species are well known and described throughout the literature. See, for example, Miki et al, supra; Klein et al. 1992. Bio/Technology 10:26; and Weisinger et al. 1988. Ann. Rev. Genet. 22:421-477. For example, the DNA construct may be introduced into the genomic DNA of the plant cell using techniques such as microprojectile-mediated delivery (Klein et al. 1987. Nature 327:70-73); electroporation (Fromm ct al. 1985. Proc. Natl. Acad. Sci. 82:5824); polyethylene glycol (PEG) precipitation (Paszkowski et al. 1984. Embo J. 3:2717-272); direct gene transfer (WO 85/01856 and EP No. 0 275 069); in vitro protoplast transformation (U.S. Pat. No. 4,684,611) and microinjection of plant cell protoplasts or embryogenic callus (Crossway, 1985. Mol. Gen. Genetics 202:179-185). Co-cultivation of plant tissue with Agrobacterium tumefaciens is another option, where the DNA constructs are placed into a binary vector system (Ishida et al. 1996. “High Efficiency Transformation of Maize (Zea mays L.) Mediated by Agrobacterium tumefaciens”. Nature Biotechnology 14:745-750). The virulence functions of the Agrobacterium tumefaciens host will direct the insertion of the construct into the plant cell DNA when the cell is infected by the bacteria. See, for example Horsch et al. 1984. Science 233:496-498, and Fraley et al. 1983. Proc. Natl. Acad. Sci. 80:4803. Corn transformation is described by Fromm et al, 1990. Bio/Technology 8:833 and Gordon-Kamm et al, supra. Agrobacterium is primarily used in dicots, but certain monocots such as maize can be transformed by Agrobacterium. U.S. Pat. No. 5,550,318.

It is preferred to select the highest level of expression of MnP, and it is thus useful to ascertain expression levels in transformed plant cells, transgenic plants and tissue specific expression. One such method is to measure the expression of the target protein as a percentage of total soluble protein. One standard assay is the Bradford assay which is well known to those skilled in the art (Bradford, M. 1976. Anal. Biochem. 72:248). The biochemical activity of the recombinant protein should also be measured and compared with a wildtype standard. The activity of MnP can be determined by the methods described in Wariishi et al. 1992. Manganese (II) oxidation by manganese peroxidase from the basidiomycete Phanerochaete chrysosporium. Kinetic mechanism and role of chelators. J. Biol. Chem. 267:23688-23695.

The levels of expression of the gene of interest can be enhanced by the stable maintenance of a MnP encoding gene on a chromosome of the transgenic plant. Use of linked genes, with herbicide resistance in physical proximity to the MnP gene, would allow for maintaining selective pressure on the transgenic plant population and for those plants where the genes of interest are not lost.

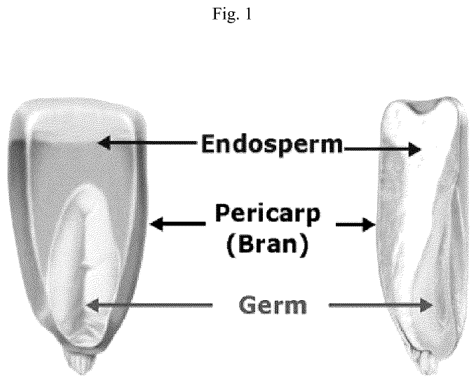

With transgenic corn plants described in the '726 patent, MnP can be produced in commercial quantities. Thus, the selection and propagation techniques described therein yield a plurality of transgenic plants that are harvested in a conventional manner. The plant seed expressing the recombinant MnP can be used in a commercial process, or the MnP extracted. When using the seed itself, it can, for example, be made into ground whole seed flour and/or ground germ flour as well as processing a protein extract from the seed or germ (see FIG. 1). In various embodiments, a composition comprising at least a portion of the transgenic corn seeds includes ground whole seed flour, ground germ flour, an extract from the seed, a protein extract from the seed, or a combination thereof.

MnP extraction from the transgenic corn seeds can be accomplished by known methods. Downstream processing for any production system refers to all unit operations after product synthesis, in this case protein production in transgenic seed (Kusnadi, A. R., Nikolov, Z. L., Howard, J. A., 1997. Biotechnology and Bioengineering. 56:473-484). Seed is processed either as whole seed ground into flour, or fractionated and the germ separated from the hulls and endosperm. If germ is used, it is usually defatted using a hexane extraction and the remaining crushed germ ground into a meal or flour. In some cases, the germ is used directly in the industrial process or the protein can be extracted (See, e.g. WO 98/39461). Extraction is generally made into aqueous buffers at specific pH to enhance recombinant protein extraction and minimize native seed protein extraction. Subsequent protein concentration or purification can follow. In the case of industrial enzymes, concentration through membrane filtration is usually sufficient.

### Treatment of Waste Materials

In various embodiments, methods for degrading a pollutant in a waste material comprise: providing a viable corn plant expressing a recombinant manganese peroxidase, wherein the recombinant manganese peroxidase is fungus-derived and is produced in a seed of the corn plant; growing the corn plant such that the recombinant manganese peroxidase is expressed; harvesting seeds from the corn plant; and contacting one or more composition(s) comprising (1) at least a portion of the seeds, and (2) a peroxide or a peroxide source, with the waste material comprising the pollutant to remove or degrade the pollutant, wherein the pollutant comprises a phenol, aniline, a hydrocarbon, or both; wherein the recombinant manganese peroxidase has at least 300 times more activity in the seeds than a wild-type manganese peroxidase expressed in its native fungus. The composition comprising at least a portion of the seeds comprises ground whole seed corn, ground germ flour, an extract from the seed, a protein extract from the seed, or a combination thereof.

The waste material comprises any municipal or industrial waste comprising the pollutant to be degraded and/or removed from the waste material. The composition of the seeds and a peroxide or a peroxide source contacts the waste material to degrade and/or remove the pollutant. The waste material includes, for example, dirt, mud, sludge, soil, textile wastewater, municipal wastewater, industrial wastewater, industrial dye, or a combination thereof.

The degradation of pollutants by MnP catalysis occurs by forming an iron peroxide complex with H₂O₂ or an organic peroxide, forming H₂O and a Fe(IV) oxo-porphyrin radical oxidized intermediate. The oxidized intermediate then oxidizes free Mn(II), a large variety of phenolic substrates, and other aromatic compounds. Accordingly, MnP oxidation of the pollutants works in the presence of H₂O₂ or biologically produced peroxide. In some embodiments, the peroxide source can be an enzyme that produces peroxide, such as a glucose oxidase enzyme. The nucleic acid sequence of a glucose oxidase enzyme from Phanerochaete chrysosporium is provided in SEQ ID NO: 4.

In various embodiments, the concentration of peroxide in the waste material is maintained at approximately 0.1 mM to approximately 10 mM. For example, the concentration of peroxide in the waste material can be 0.1 mM, 0.2 mM, 0.4 mM, 0.6 mM, 0.8 mM, 1.0 mM, 1.2 mM, 1.4 mM, 1.6 mM, 1.8 mM, 2.0 mM, 2.2 mM, 2.4 mM, 2.6 mM, 2.8 mM, 3.0 mM, 3.5 mM, 4.0 mM, 4.5 mM, 5.0 mM, 6.0 mM, 6.5 mM, 7.0 mM, 7.5 mM, 8.0 mM, 8.5 mM, 9.0 mM, or 10.0 mM. In various embodiments, the concentration of the recombinant MnP in the waste material is maintained at approximately 0.1 unit/mL to 10 units/mL. For example, the concentration of MnP in the waste material can be 0.1 unit/mL, 0.2 unit/mL, 0.4 unit/mL, 0.6 unit/mL, 0.8 unit/mL, 1.0 unit/mL, 1.2 unit/mL, 1.4 unit/mL, 1.6 unit/mL, 1.8 unit/mL, 2.0 unit/mL, 2.2 unit/mL, 2.4 unit/mL, 2.6 unit/mL, 2.8 unit/mL, 3.0 unit/mL, 3.5 unit/mL, 4.0 unit/mL, 4.5 unit/mL, 5.0 unit/mL, 6.0 unit/mL, 6.5 unit/mL, 7.0 unit/mL, 7.5 unit/mL, 8.0 unit/mL, 8.5 unit/mL, 9.0 unit/mL, or 10.0 unit/mL.

In various embodiments, the contacting of the one or more composition(s) comprising (1) at least a portion of the seeds, and (2) a peroxide or a peroxide source, with the waste material proceeds for at least approximately five minutes. For example, the contacting can proceed for at least three hours.

In various embodiments, the contacting of the one or more composition(s) comprising (1) at least a portion of the seeds, and (2) a peroxide or a peroxide source, with the waste material proceeds at approximately pH 4 to approximately pH 6. At least approximately 80% of the pollutant can be removed from the waste material. In some cases, the oxidized pollutant precipitates out of the waste material.

### Embodiments

Various embodiments of the systems, methods, and compositions provided herein are included in the following non-limiting list of embodiments.

1. A method for degrading a pollutant in a waste material, comprising:
providing a viable corn plant expressing a recombinant manganese peroxidase, wherein the recombinant manganese peroxidase is fungus-derived and is produced in a seed of the corn plant;
growing the corn plant such that the recombinant manganese peroxidase is expressed;
harvesting seeds from the corn plant; and
contacting one or more composition(s) comprising (1) at least a portion of the seeds, and (2) a peroxide or a peroxide source, with the waste material comprising the pollutant to remove or degrade the pollutant, wherein the pollutant comprises a phenol, a phenol derivative, an aromatic amine, a hydrocarbon, or a combination thereof;
   wherein the recombinant manganese peroxidase has at least 300 times more activity in the seeds than a wild-type manganese peroxidase expressed in its native fungus.

2. The method of embodiment 1, wherein the fungus is a white rot fungus Phanerochaete chrysosporium.

3. The method of embodiment 1, wherein the corn plant comprises at least one expression cassette having a heterologous promoter operably linked to a nucleic acid segment encoding the recombinant manganese peroxidase with at least 95% sequence identity to an amino acid sequence of SEQ ID NO: 1.

4. The method of embodiment 3, wherein the heterologous promoter is a promoter of a maize globulin-1 gene.

5. The method of embodiment 1, wherein the pollutant comprises a chlorophenol, a monoaromatic phenol, an aromatic alcohol, an amine, aniline, 2-Methoxy-5-methylaniline, lignin, 2-chlorophenol, 3-chlorophenol, 4-chlorophenol, 2,4-dichlorophenol, bisphenol A, p-cresol, m-cresol, o-cresol, 2-methoxyphenol, 3-methoxyphenol, 4-methoxyphenol, a polyaromatic hydrocarbon, a chlorinated hydrocarbons, an aromatic dye, or a combination thereof.

6. The method of embodiment 5, wherein the aromatic dye is a synthetic organic azo dye, and aromatic amine metabolite of the dye, or a combination thereof.

7. The method of embodiment 1, wherein the pollutant comprises a cannabinoid.

8. The method of embodiment 7, wherein the cannabinoid comprises tetrahydrocannabinol or cannabidiol.

9. The method of embodiment 1, wherein the waste material comprises a byproduct of oil production.

10. The method of embodiment 1, wherein the composition comprising at least a portion of the seeds is ground whole seed corn, ground germ flour, an extract from the seed, a protein extract from the seed, or a combination thereof.

11. The method of embodiment 1, wherein the waste material is dirt, mud, sludge, soil, textile wastewater, municipal wastewater, industrial wastewater, or a combination thereof.

12. The method of embodiment 1, wherein the peroxide source is a glucose oxidase enzyme.

13. The method of embodiment 12, wherein the concentration of peroxide in the waste material is maintained at approximately 0.1 mM to 10 mM.

14. The method of embodiment 1, wherein the concentration of the recombinant manganese peroxidase in the waste material is maintained at approximately 0.1 unit/mL to 10 units/mL.

15. The method of embodiment 1, wherein the contacting of the one or more composition(s) comprising (1) at least a portion of the seeds, and (2) a peroxide or a peroxide source, with the waste material proceeds for at least approximately five minutes.

16. The method of embodiment 15, wherein the contacting of the one or more composition(s) comprising (1) at least a portion of the seeds, and (2) a peroxide or a peroxide source, with the waste material proceeds for at least three hours.

17. The method of embodiment 1, wherein the contacting of the one or more composition(s) comprising (1) at least a portion of the seeds, and (2) a peroxide or a peroxide source, with the waste material proceeds at approximately pH 4 to approximately pH 6.

18. The method of embodiment 1, wherein at least approximately 80% of the pollutant is removed from the waste material.

### EXAMPLES

The following examples are not intended to limit the scope of what the inventors regard as their invention.

### Example 1: Materials and Methods

1. Enzyme production and preparation.

Hybrid transgenic lines producing Mn Peroxidase were grown in the field in Arkansas during the summer season. The corn grain was processed to recover the germ from whole corn kernels. The germ was ground and extracted with 50 mM sodium tartrate pH 4.5 for 1 hour. The extract was filtered to remove the flour and precipitated with 95% ammonium sulfate (AS). The AS pellet was extracted in sodium tartrate and concentrated and desalted on a Millipore Pellicon-2 Tangential Flow Filtration unit. The average concentration of the extract was approximately 25 mg/mL. The specific activity of the MnP is 2.65 Units/mg protein, defined by turnover of 1 mM H₂O₂.

### 2. Buffer Preparation.

Tartrate buffers (0.5 M) were made for pH 4.5, from sodium L-tartrate dibasic dihydrate and sulfuric acid or from tartaric acid and NaOH.

### 3. Manganese Peroxidase Enzyme Activity Assay.

The assay used herein for determining MnP activity is described in Hood, E., et. al., Manganese peroxidase from the white-rot fungus Phanerochaete chrysosporium is enzymatically active and accumulates to high levels in transgenic maize seed, Plant Biotechnology Journal (2006) 4, pp. 53-62.

Activity Assay Conditions: 50 mM tartrate buffer, pH 4.5, 0.5 mM each of MnSO₄ and DMP, 0.05 mM peroxide with appropriate amount of enzyme for 5 min at 469 nm (a single-time-point kinetic assay). 1.0 mM MnSO₄ and/or 0.1 mM peroxide can also be used. An enzyme unit is 1 umol/min under ideal conditions (in particular, pH and saturating concentrations of substrate(s)). MnP catalyzes the oxidation of 2,6-DMP to the corresponding phenoxy radical at the expense of H₂O₂. This generates the 2,6-DMP radical. Two 2,6-DMP radicals dimerize rapidly to hydrococrulignone, which again is quickly converted to cocrulignone by H₂O₂ (with or without enzyme). The stoichiometry of the peroxidase reaction is 1:1. The product, cocrulignone (or, 3,3′,5,5′-tetramethoxydiphenoquinone) has λₘₐₓ 469 nm and ε 53,200 M⁻¹·cm⁻¹ (26,600 per peroxide).

Enzyme activity was measured in standard catalytic units (U/mL). 1.0 U is equal to the consumption of 1.0 μmol of H₂O₂ per minute. Oxidative dimerization of 2,6-dimethoxyphenol (2,6-DMP) in the presence of manganese (II) sulfate (MnSO₄), H₂O₂ and manganese peroxidase (MnP) produces a pink chromophore at 469 nm (8=53200 M⁻¹*cm⁻¹). The initial rate of this reaction is used for MnP activity and measured by a built-in kinetic rate calculation function in the UV-Vis spectrometer. The reagent was prepared in buffer containing 10 mM 2,6-DMP (5.0 mL), 100 mM H₂O₂ (50 μL), 5 mM manganese (II) sulfate (MnSO₄; 5.0 mL) and 0.5 M tartrate buffer (4.0 mL), made up to 50 mL with water.

A 50-fold diluted enzyme was prepared and 50 μL of it was added into a quartz cuvette followed by quick addition of 950 μL of freshly prepared reagent. Then in kinetic mode, with the instrument correction factor of 45, the change in the absorbance at 469 nm was monitored from 0 seconds to 30 seconds at 5 second intervals. The rate is calculated as Δ A496 per min and activity in U/mL.

### 4. UV-Vis Spectrometry.

An Agilent (Mississauga, ON) diode array UV-Vis spectrophotometer (model 8453 controlled by a Hewlett Packard Vectra ES/12 computer) with a range of 190-1100 nm and 1 nm resolution, was applied to measure the λₘₐₓ of each compound, observe the reactions and also the enzyme activity. The λₘₐₓ for each compound was further used in HPLC analysis of the samples. Quartz cuvettes with 1 cm path length type 104-QS were obtained from Hellma (Concord, ON) for the analysis in UV region.

### 5. HPLC Analysis.

Substrate concentrations were calculated using a Waters HPLC system with model 2489 dual-wavelength absorbance detector, model 2707 auto-sampler, and model 1525 binary pumps, equipped with Symmetry C18 Columns, 100 Å, 5 μm, 4.6 mm*150 mm from Waters Ltd. (Mississauga, Ontario). The HPLC is run by Breeze 2.0 software. Choice and ratio of the mobile phases, detection wavelength and flow rate used for each substrate are given in Table 1. The injection volume was kept constant at 10 μL for all samples. Column temperature was held at 25° C.

TABLE 1
HPLC conditions for substrates run under isocratic elution.

| | Mobile phase ratio | | Flow | λₘₐₓ |
|---|---|---|---|---|
| Substrate | Pump A | Pump B | mL/min | nm |
| CBD | 20% formic | 80% ACN + | 1.0 | 270 |
| | acid (0.1%) | formic acid | | |
| | | (0.1%) | | |
| THC | 20% formic | 80% ACN + | 1.0 | 280 |
| | acid (0.1%) | formic acid | | |
| | | (0.1%) | | |
| Phenol | 65% formic | 35% ACN | 1.0 | 270 |
| | acid (0.1%) | | | |
| 2-Chlorophenol | 50% formic | 50% ACN + | 1.0 | 280 |
| | acid (0.1%) | formic acid | | |
| | | (0.1%) | | |
| 3-Chlorophenol | 50% formic | 50% ACN | 1.0 | 275 |
| | acid (0.1%) | | | |
| 4-Chlorophenol | 50% formic | 50% ACN + | 1.0 | 280 |
| | acid (0.1%) | formic acid | | |
| | | (0.1%) | | |
| 2,4-Dichlorophenol | 50% formic | 50% ACN + | 1.0 | 285 |
| | acid (0.1%) | formic acid | | |
| | | (0.1%) | | |
| p-cresol | 50% formic | 50% ACN + | 1.0 | 275 |
| | acid (0.1%) | formic acid | | |
| | | (0.1%) | | |
| m-cresol (outlawed | 50% formic | 50% ACN | 1.0 | 270 |
| wood treatment, | acid (0.1%) | | | |
| fenceposts to | | | | |
| keep from | | | | |
| falling apart) | | | | |
| o-cresol | 50% formic | 50% ACN | 1.0 | 270 |
| | acid (0.1%) | | | |
| 2-Methoxyphenol | 65% formic | 35% ACN + | 1.0 | 275 |
| | acid (0.1%) | formic acid | | |
| | | (0.1%) | | |
| 3-Methoxyphenol | 65% formic | 35% ACN | 1.0 | 273 |
| | acid (0.1%) | | | |
| 4-Methoxyphenol | 65% formic | 35% ACN | 1.0 | 285 |
| | acid (0.1%) | | | |
| Aniline | 50% ammonium | 50% ACN | 1.0 | 280 |
| | formate (5 mM) | | | |
| 2-Methoxy-5- | 65% formic | 35% ACN + | 1.0 | 275 |
| methylaniline | acid (0.1%) | formic acid | | |
| | | (0.1%) | | |

### 6. Other Instruments.

The pH meter was Oakton pH 700 benchtop meter with pH resolution 0.01 and pH range 0.00 to 14.00 (Vermon Hills, IL), connected to a Thermo Scientific Orion pH Probe (9110DJWP, Refillable/DJ/Semi-Micro/Glass) with ±0.02 pH accuracy. Calibration buffers (pH 4.00, 7.00 and 10.00) were from ACP Chemicals Inc. Centrifugation was done on a Corning LSE™ compact centrifuge with 6*50 mL and 6*15 mL centrifuge tubes and a maximum speed of 6000 rpm (New York, USA). VWR International Inc. (Mississauga, ON), supplied the Micro V magnetic stirrers (0-1100 rpm, model 4805-00) and VWR Magstirrers (100-1500 rpm, model 82026-764). The magnetic stir bars were from Cole-Parmer Canada Inc. (Montreal, QC). Model K-550-G vortex mixer (50/60 Hz, 0.5 Amps, 120 volts) was from Scientific Industries, Inc (Bohemia, NY).

### Example 2: Oxidative Polymerization of Target Heterocyclic Aromatics with Manganese Peroxidase (Batch Reactor Formulation)

30 mL glass batch reactors were used to conduct all reactions. The reactions were performed at about 19-25° C. and were not temperature controlled. The enzymatic treatment of synthetic wastewater was planned for 95% removal of each substrate, in 20 mL solution. The reaction medium was comprised of 0.1 or 0.5 or 1.0 mM of a single substrate in 40 mM buffer along with manganese sulfate in 0.20 mol ratio to the organic substrate and manganese peroxidase. Hydrogen peroxide was added last, either as a single addition or as 7 portions of 1 mM each at 10 min intervals. After stirring the mixture for 180 minutes by Teflon-coated magnetic stir bars, 100 uL catalase stock solution (0.1 g/10 mL) was added to quench the reaction by consuming residual hydrogen peroxide. Syringe filters (0.2 μm, non-sterile) from Sarstedt (Montreal, QC) were used to filter the samples before HPLC measurements.

Enzyme concentration, hydrogen peroxide concentration, and reaction time parameters were studied for all substrates. For pH, the reactions were run at pH 4.5, the optimum pH for MnP (Clough et al., 2005). Every set of batch reactors had a pair of blanks, formulated in the same way as samples. One blank did not have hydrogen peroxide to check the effect of enzyme on the substrate and the other one was lacking enzyme, to observe the effect of hydrogen peroxide alone on the substrate. The reactions were run for 180 minutes, stopped with catalase and microfiltered before HPLC analysis.

Hydrogen peroxide optimization was followed by enzyme optimization. The reaction was formulated for 95% removal of target compound, at optimum pH 4.5. If 95% removal was not achieved during optimization, a residual hydrogen peroxide assay was used to determine if the amount of hydrogen peroxide was the limiting factor and then experiments were reformulated appropriately.

Reaction time requirement was studied using optimal pH, enzyme concentration and hydrogen peroxide concentration for 180 min. Batch reactors with 20-50 mL volume were prepared. Samples (5 or 20 mL) were taken at short time intervals, quenched with catalase and vortexed to stop the reaction. Then, samples were microfiltered and analyzed for residual substrate by HPLC.

Chemicals that were found to be degraded by corn-kernel-produced Manganese peroxidase include the chemicals listed in FIG. 2.

### Example 3. Detection of Oxidative Oligomers by Mass Spectrometry

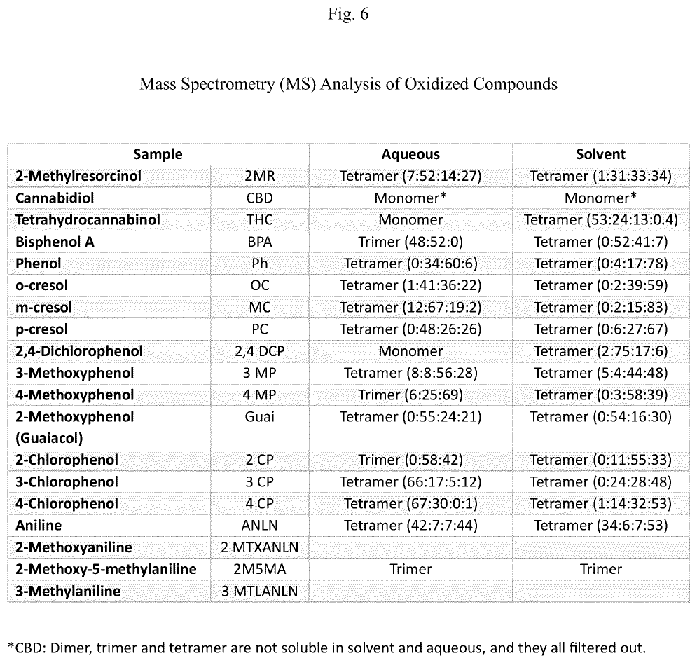

Referring to FIG. 6, detection of oxidative oligomers up to the tetramer stage of enzymatic products in soluble and insoluble parts of reactions with MnP, peroxide, and the indicated compounds is shown. Use of organic solvent represents oligomers precipitated from the aqueous reaction mixtures which were brought back into solution by the solvent. In the cases of THC, BPA, 2,4-diCl-, 4-methoxy-, and 2-chloro-phenols this is clearly demonstrated. In the other cases, which have the same entries in the aqueous and solvent columns (eg. tetramer, tetramer), the ratios in brackets indicate the mass spectrometry peak area ratios of monomer, dimer, trimer and tetramer, respectively. In all cases, these distributions shift to the higher oligomers in the solvent, indicating the higher oligomer(s) have been brought back into solution.

What is claimed is:

1. A method for degrading a pollutant in a waste material, comprising:
providing a viable corn plant expressing a recombinant manganese peroxidase, wherein the recombinant manganese peroxidase is fungus-derived and is produced in a seed of the corn plant;
growing the corn plant such that the recombinant manganese peroxidase is expressed;
harvesting seeds from the corn plant; and
contacting one or more composition(s) comprising (1) at least a portion of the seeds, and (2) a peroxide or a peroxide source, with the waste material comprising the pollutant to remove or degrade the pollutant, wherein the pollutant comprises a phenol, a phenol derivative, an aromatic amine, a hydrocarbon, or a combination thereof;
wherein the recombinant manganese peroxidase has at least 4 times more activity in the seeds than a wild-type manganese peroxidase expressed in its native fungus.

2. The method of claim 1, wherein the fungus is a white rot fungus Phanerochaete chrysosporium.

3. The method of claim 1, wherein the corn plant comprises at least one expression cassette having a heterologous promoter operably linked to a nucleic acid segment encoding the recombinant manganese peroxidase with at least 95% sequence identity to an amino acid sequence of SEQ ID NO: 1.

4. The method of claim 3, wherein the heterologous promoter is a promoter of a maize globulin-1 gene.

5. The method of claim 1, wherein the pollutant comprises a chlorophenol, a monoaromatic phenol, an aromatic alcohol, an amine, aniline, 2-Methoxy-5-methylaniline, lignin, 2-chlorophenol, 3-chlorophenol, 4-chlorophenol, 2,4-dichlorophenol, bisphenol A, p-cresol, m-cresol, o-cresol, 2-methoxyphenol, 3-methoxyphenol, 4-methoxyphenol, a polyaromatic hydrocarbon, a chlorinated hydrocarbons, an aromatic dye, or a combination thereof.

6. The method of claim 5, wherein the aromatic dye is a synthetic organic azo dye, and aromatic amine metabolite of the dye, or a combination thereof.

7. The method of claim 1, wherein the pollutant comprises a cannabinoid.

8. The method of claim 7, wherein the cannabinoid comprises tetrahydrocannabinol or cannabidiol.

9. The method of claim 1, wherein the waste material comprises a byproduct of oil production.

10. The method of claim 1, wherein the composition comprising at least a portion of the seeds is ground whole seed corn, ground germ flour, an extract from the seed, a protein extract from the seed, or a combination thereof.

11. The method of claim 1, wherein the waste material is dirt, mud, sludge, soil, textile wastewater, municipal wastewater, industrial wastewater, or a combination thereof.

12. The method of claim 1, wherein the peroxide source is a glucose oxidase enzyme.

13. The method of claim 12, wherein the concentration of peroxide in the waste material is maintained at approximately 0.1 mM to 10 mM.

14. The method of claim 1, wherein the concentration of the recombinant manganese peroxidase in the waste material is maintained at approximately 0.1 unit/mL to 10 units/mL.

15. The method of claim 1, wherein the contacting of the one or more composition(s) comprising (1) at least a portion of the seeds, and (2) a peroxide or a peroxide source, with the waste material proceeds for at least approximately five minutes.

16. The method of claim 15, wherein the contacting of the one or more composition(s) comprising (1) at least a portion of the seeds, and (2) a peroxide or a peroxide source, with the waste material proceeds for at least three hours.

17. The method of claim 1, wherein the contacting of the one or more composition(s) comprising (1) at least a portion of the seeds, and (2) a peroxide or a peroxide source, with the waste material proceeds at approximately pH 4 to approximately pH 6.

18. The method of claim 1, wherein at least approximately 80% of the pollutant is removed from the waste material.
